(19) United States
(12) Patent Application Publication
(10) Pub. No.: US 2007/0081351 A1
(43) Pub. Date: Apr. 12, 2007

(54) Car lamp structure

(76) Inventor: Mei-Chen Liu, Yongkang City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/213,691

(22) Filed: Aug. 30, 2005

(51) Int. Cl. F21V 1/00

(52) U.S. Cl. 362/509

(57) ABSTRACT

A car lamp includes a lamp shell, a reflecting shade ahead of the lamp shell, a bulb on the reflecting shell, a set-off member ahead of the reflecting shade, and a pervious-to-light lamp cover secured ahead of the set-off member; the reflecting shade has several reflecting surfaces; the set-off member has a pervious-to-light cover on a middle portion, several concave portions around the pervious-to-light cover, through holes respectively connected to rear ends of the concave portions and faced with the reflecting surfaces of the reflecting shade; the set-off member further has several reflecting surfaces on each of inner sides of the concave portions, and several pervious-to-light plates respectively fitted in the through holes thereof; therefore, when the bulb shines, the whole car lamp will look like it has several light emitting diodes shining therein.

### BACKGROUND OF THE INVENTION

1. Field of the Invention

The present invention relates to a car lamp, more particularly one, which is equipped with a set-off member having several through concave portions, several reflecting surfaces on each of inner sides of the concave portions, and pervious-to-light plates respectively positioned behind the concave portions such that when a bulb of the lamp shines, the whole car lamp will look like it has several light emitting diodes shining therein.

2. Brief Description of the Prior Art

A conventional car lamp includes a lamp shell, a reflecting shade in front of the lamp shell, a bulb on a front side of the reflecting shade, and a pervious-to-light lamp cover secured in front of the bulb and the reflecting shade. The pervious-to-light lamp cover can be red, yellow or colorless, and light emitted from the car lamp will be the same color as the pervious-to-light lamp cover; the car lamp can be used as a warning light if the lamp cover is red; the car lamp can be used as a blinker if the lamp cover is yellow; the car lamp can be used as a back-up light if the lamp cover is colorless.

However, when the bulb shines, such car lamp will only produce monotonous light obviously from single light source. Consequently, such car lamp is much less popular than those with several light emitting diodes (LED) therein.

### SUMMARY OF THE INVENTION

It is a main object of the invention to provide an improvement on a car lamp to overcome the above-mentioned problem. The car lamp of the present invention includes a lamp shell, a reflecting shade ahead of the lamp shell, a bulb on the reflecting shell, a set-off member ahead of both the bulb and the reflecting shade, and a pervious-to-light lamp cover secured ahead of the set-off member. The reflecting shade has several reflecting surfaces. The set-off member has a pervious-to-light cover on a middle portion thereof, several concave portions around the pervious-to-light cover, through holes respectively connected to rear ends of the concave portions and faced with the reflecting surfaces of the reflecting shade. The set-off member further has several reflecting surfaces on each of inner sides of the concave portions, and several pervious-to-light plates respectively fitted in the through holes thereof. Therefore, when the bulb shines, the whole car lamp will look like it has several light emitting diodes shining therein.

### BRIEF DESCRIPTION OF THE DRAWINGS

The present invention will be better understood by referring to the accompanying drawings, wherein:

FIG. 1 is an exploded perspective view of the car lamp according to the present invention,

FIG. 2 is a front view of the car lamp of the invention,

FIG. 3 is a side view of the car lamp of the invention, and

FIG. 4 is a view of the second preferred embodiment.

### DETAILED DESCRIPTION OF THE PREFERRED EMBODIMENTS

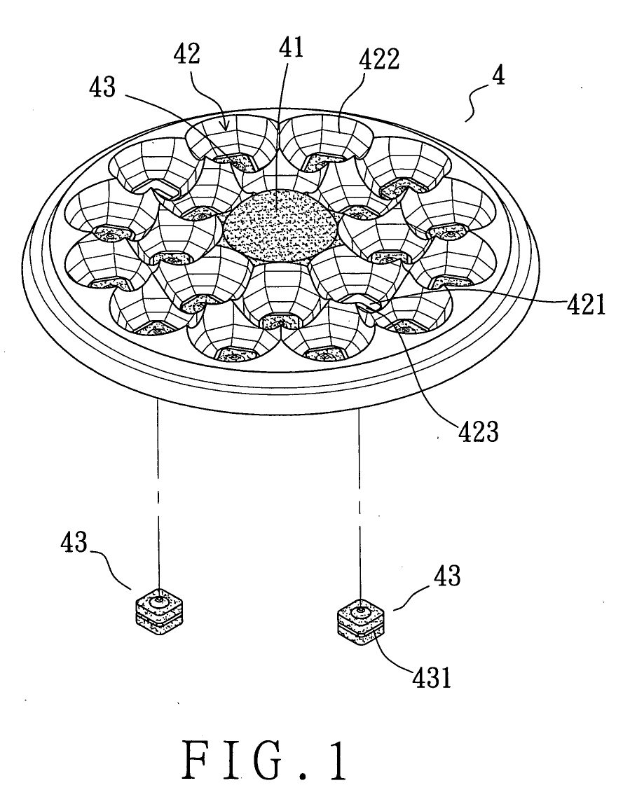

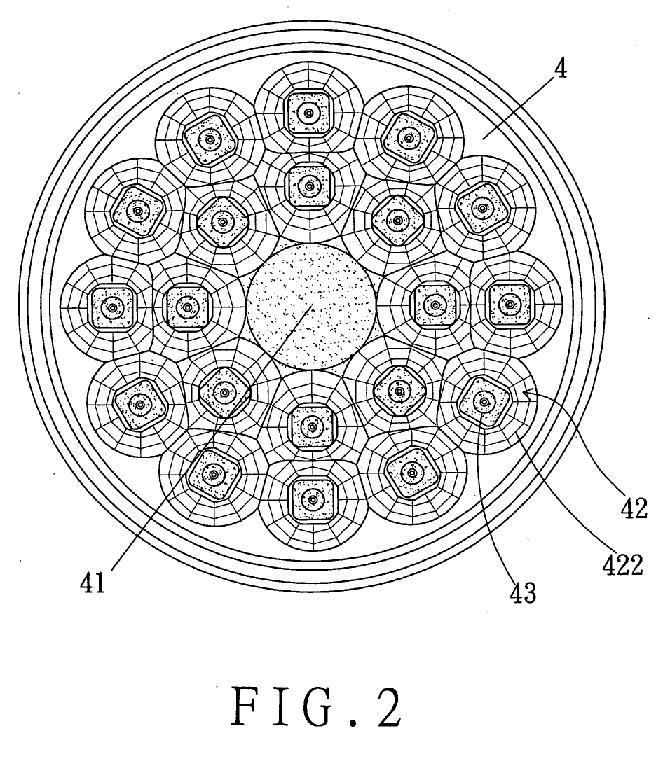

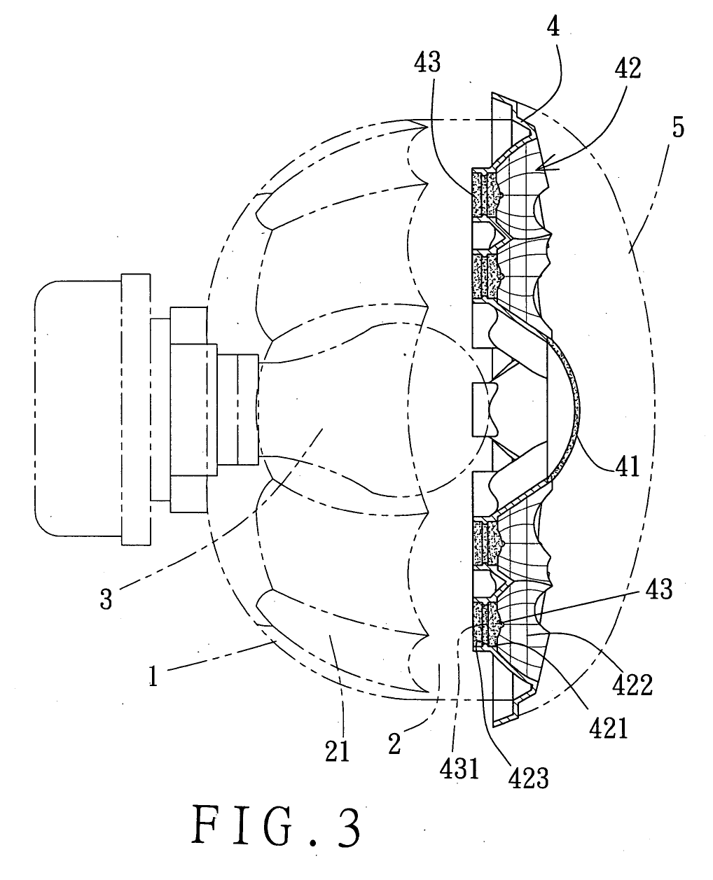

Referring to FIGS. 1 to 3, a preferred embodiment of a car lamp of the present invention includes a lamp shell 1 on a rear side, a reflecting shade 2 in front of the lamp shell 1, a bulb 3 on a front side of the reflecting shade 2, a set-off member 4, and a pervious-to-light lamp cover 5.

The reflecting shade 2 has several reflecting surfaces 21 on the front side thereof. The set-off member 4 is positioned in front of both the reflecting shade 2 and the bulb 3, and it has a pervious-to-light cover 41 on a middle portion thereof, many concave portions 42 around the pervious-to-light cover 41 on a front side, and through holes 421, which are respectively connected to rear ends of the concave portions 42, and faced with the reflecting surfaces 21 of the reflecting shade 2 such that light reflected by each of the reflecting surfaces 21 will travel through the corresponding through hole 421 and concave portion 42. The concave portions 42 are in the shape of a bowl. The set-off member 4 has an engaging portion 423 in each of the through holes 421, and many reflecting surfaces 422 on each of inner sides of the concave portions 42. The set-off member 4 further has pervious-to-light plates 43, each of which has an engaging recess 431 on an outer side. The pervious-to-light plates 43 are respectively fitted in the through holes 421 with the engaging portions 423 being fitted in the engaging recesses 431 thereof. The pervious-to-light lamp cover 5 is secured in front of the set-off member 4.

Therefore, when the bulb 3 shines, some of the light from the bulb will travel through the pervious-to-light cover 41 of the set-off member 4 directly, and the rest of the light will be reflected by the reflecting surfaces 21 of the reflecting shade 2, and travel outside the car lamp through the through holes 421 and the concave portions 42 of the set-off member 4; the reflecting surfaces 422 the concave portions 42 will reflect the light traveling through the concave portions 42 in such a way that the whole car lamp looks like it has several light emitting diodes (LED) shining therein.

The pervious-to-light lamp cover 41 and the pervious-to-light plates 43 of the set-off member 4 can be red, yellow or colorless; the car lamp can be used as a warning light if the pervious-to-light cover 41 and the pervious-to-light plates 43 are red; the car lamp can be used as a blinker if the pervious-to-light cover 41 and the pervious-to-light plates 43 are yellow; the car lamp can be used as a back-up light if the pervious-to-light cover 41 and the pervious-to-light plates 43 are colorless.

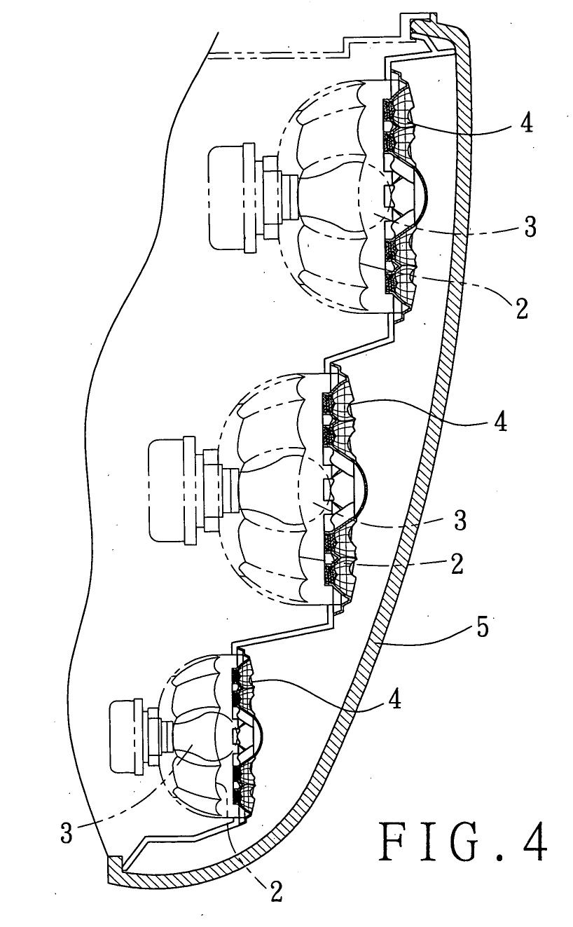

Furthermore, referring to FIG. 4, a second preferred embodiment of a car lamp of the invention is comprised of several lamps of the above structure, which are used as a warning light, a blinker, and a back-up light respectively.

From the above description, it can be easily seen that when the bulb is powered, the car lamp of the present invention will look like it has several light emitting diodes shining therein because of the set-off member thereof.

What is claimed is:

1. A car lamp structure, comprising a lamp shell;
a reflecting shade in front of the lamp shell; the reflecting shade having a plurality of reflecting surfaces on a front side thereof;
a bulb on the front side of the reflecting shade;
a set-off member positioned in front of the reflecting shade; the set-off member having a pervious-to-light cover on a middle portion thereof; the set-off member having a plurality of concave portions around the pervious-to-light cover on a front side thereof; the set-off member having through holes, which are respectively connected to rear ends of the concave portions; the through holes being respectively faced with the reflecting surfaces of the reflecting shade; the set-off member having a plurality of reflecting surfaces on each of inner sides of the concave portions; the set-off member having plural pervious-to-light plates respectively fitted in the through holes thereof; and
a pervious-to-light lamp cover secured in front of the set-off member.
